(19) United States
(12) Patent Application Publication
(10) Pub. No.: US 2001/0027089 A1
(43) Pub. Date: Oct. 4, 2001

(54) Mobile phone improvements

(76) Inventor: Hassan P.A. Salam, London (GB)

Correspondence Address: Dykema Gossett PLLC, Suite 300 West, 1300 I Street, N.W., Washington, DC, 20005-3306, US

(21) Appl. No.: 09/820,697

(22) Filed: Mar. 30, 2001

(30) Foreign Application Priority Data
Apr. 4, 2000 (GB) GB 0008239.6
May 11, 2000 (GB) GB 0011427.2
Dec. 7, 2000 (GB) GB 0029921.4

(51) Int. Cl. H04B 1/38

(52) U.S. Cl. 455/90; 455/569

(57) ABSTRACT

A mobile phone comprises an car-piece for transmitting sound in a first direction a transducer for converting electrical signals into speech sound, and a dielectric member having an acoustic duct that extends in a direction that is normal to the first direction, the acoustic duct guiding sound generated by the transducer to the ear-piece. By this arrangement all radiating parts of the mobile can be kept away from the ear. The earpiece is movable relative to the casing of the mobile phone.

### FIELD AND BACKGROUND OF THE INVENTION

The present invention is concerned with reducing radiation from a mobile phone into the brain of its user. There is concern that such radiation may possible be harmful to parts of the brain.

Currently available mobile phones comprise a housing that includes a set of operating keys, a display at a top portion of the mobile phone, a radio frequency transceiver, an aerial at the top portion of the mobile phone, a microphone, a speaker at the top portion of the mobile phone that converts electrical speech signals into sound, and wiring for interconnecting these items. In use, the speaker is placed at the ear, with the aerial also close to or at the ear. The speaker, being a wired electrical part, radiates radio waves straight into the car and, therefore, into the brain. All metallic parts in the mobile phone reflect or re-radiate radio waves emanating from the aerial Also, the aerial itself is very close to the brain and therefore transmits strong radio waves into the brain.

In order to reduce the risk of radiation into the brain many users of mobile phones have resorted to using a hands-free kit, the conventional hands-free kit consists of a cable having a plug that fits into the mobile phone. The cable has a microphone part Ad ax along its length, and terminates in an earphone that is fitted to the ear. It has been supposed that the hands-free kit provides protection against radiation into the brain, since the mobile phone casing containing the transmitter can be placed away from the head, for example in a pocket. However, some tests that have been carried out indicate that the cable of the hands-free kit can guide radio staves into the brain via the ear, in some cases causing higher radiation in portions of the brain than when the kit is not resorted to.

### SUMMARY OF THE INVENTION

A mobile phone according to the present invention comprises an ear-piece for transmitting sound in a first direction; a transducer for converting electrical signals into speech sound; and a dielectric member having an acoustic duct that extends in a direction that is normal to the first direction, the acoustic duct guiding sound generated by the transducer to the ear-piece. By this, all metallic parts of the mobile phone (which parts are sources of radio frequency radiation or re-radiation) can be kept well away from the ear and brain.

### BRIEF DESCRIPTION OF THE DRAWINGS

FIG. 1 illustrates schematically a mobile phone according to a first embodiment of the invention.

FIG. 2 illustrates schematically a second embodiment of the invention, using a telescopic sound guide.

FIG. 3 illustrates schematically a third embodiment of the invention comprising a hands-free kit.

### DESCRIPTION OF PREFERRED EMBODIMENTS

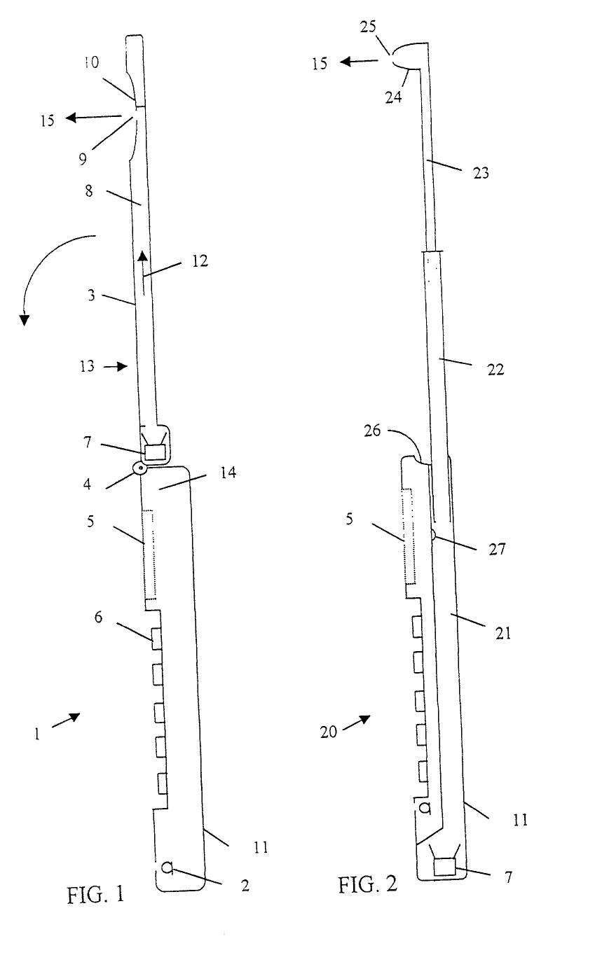

FIG. 1 illustrates schematically the first embodiment of the invention. As shown, mobile phone assembly 1 includes a lid 3 of dielectric material that can rotate about a hinge 4, a display screen 5, a microphone 2, and operating keys 6. Included in lid 3 is a transducer 7 that is close to hinge 4 and that converts electrical energy into sound. Speech sound from transducer 7 is transmitted via a duct 8 in lid 3 to exit from lid 3 at an opening 9 in the direction of arrow 15 into the user's ear. Opening 9 is in a dished portion 10 of lid 3 that services as the earpiece of the mobile phone. By this arrangement all electrical parts of the mobile phone can be kept several centimeters away from the ear. The length of the lid can range from 7 cm to 15 cm or more, consequently hole 9, opposite the car, can be about 5 cm to 13 cm areas from all metal parts of the phone. Transducer 7 is connected to circuits in mobile phone I by a flexible cable not shown. Sound duct 8 can have a cross section of any shape, for example the cross section can be a 2 millimeter diameter circle. Lid 3 can be made wholly or partly transparent so as to allow display 5 to be seen even if lid 3 is in the folded position, i.e. covering the display. Mobile phone casing includes an aerial and a radio frequency transmitter and receiver (not shown) for communication with base stations. The aerial may be wholly or partly inside casing 11.

During talking using mobile phone 1, earpiece 10 is pressed against the user's car. The direction 12 in which sound is guided by duct 8 is normal to the direction of arrow 15.

If desired, transducer 7 can be placed inside casing, 11 it shown location 14, in which case holes are provided at the top of casing 11 and the bottom of lid 3 so as to provide unobstructed transmission of sound from transducer 7 to duct 8.

FIG. 1 shows lid 3 hinged to casing 11 so that it can swing to cover the front face of casing 11 when not in use. It is possible to re-arrange lid 3 so that It is hinged to casing 11 so as to cover the back of casing 11 when not in use.

FIG. 2 illustrates schematically a second embodiment of the invention. As shown, mobile phone assembly 20 includes the transducer 7 arranged to deliver speech sound into the bottom of a cylindrical tube 21. Contained in cylindrical tube 21 is a cylindrical tube 22 of non-metallic material, and inside tube 22 is a cylindrical tube 23, also of nonmetallic material. The top end of tube 23 terminates in a non-metallic earpiece 24 having an opening 25. By this arrangement, speech sound from speaker 7 is transmitted through hollow tubes 21, 22, 33 in succession to pass through opening 25 in earpiece 24. The arrangement of the tubes is telescopic. Tube 22 is prevented from sliding right out of tube 21 by stop means not shown. Tube 23 slides in tube 22, and tube 22 slides in tube 21. Thus when mobile phone 20 is not in use tubes 22, 23 can be nested in casing 11 of mobile phone 20, with earpiece 25 nesting in pocket 26. By this arrangement, during talking on the phone, all electrical parts of the phone can be positioned away from earpiece 24 by more than the length of the phone. Thus, for example, if the length of the phone is 10 cm, the distance between ear-piece 24 and the electrical parts in the phone can be greater than 15 cm. Optionally, there can be more than two sliding tubes acting as sound ducts. A switch 27 is provided which disables transducer 7 when tube 22 is not pulled out.

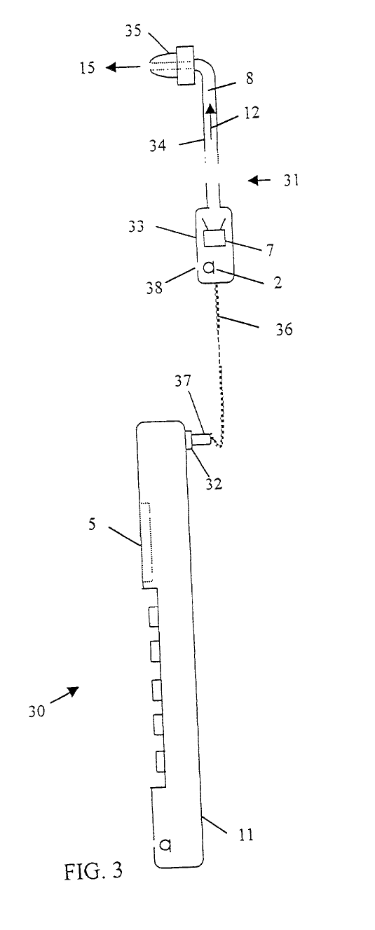

FIG. 3 illustrates another embodiment of the invention. Mobile phone assembly 30 includes a main unit having a casing 11 and a hands-free kit 31. The main unit can be a conventional mobile phone complete with a radio frequency transceiver, an aerial, a microphone, a speaker, display operating keys, etc., and a socket 32 for connection to a hands-free kit.

In the assembly of FIG. 3, hands free kit 31 comprises a small housing unit 33 containing a speaker 7 and a microphone 2. Speaker 7 delivers speech sound into a bent dielectric tube 34 which in turn passes the sound via a hollow in dielectric earpiece 35 into the ear of the user. A cable 36 with a plug 37 electrically connects microphone 2 and speaker 7 to circuits in casing 11. The inside of tube 34 provides the acoustic duct 8. Tube 34 is can be 2-20 centimeters long and can include soft flexible material. The direction 15 of sound emanating from earpiece 34 is normal to the direction of sound travel in tube 34 indicated by arrow 12. Microphone 2 picks up the user's speech though an aperture 38 in housing 33. In all of the arrangements that have been described all electrical parts can easily be kept 10 centimeters or more away from the ear and brain. The arrangements of FIGS. 1. 2 have the advantage that they provide protection against phone radiation without using a hands-free kit. The advantage of the arrangement of FIG. 3 is that the kit 31 can be used with most of the existing mobile phones.

1. A mobile phone assembly comprising: a housing that contains a radio transceiver and that supports an aerial; an ear-piece for transmitting sound in a first direction: a transducer for converting electrical signals into speech sound: and a dielectric member having an acoustic duct that extends in a longitudinal direction that is normal to said first direction, said acoustic duct guiding sound generated by said transducer into said car-piece.

2. A mobile phone assembly according to claim 1 including a lid that is hinged to said housing, said lid comprising said earpiece and said duct.

3. A mobile phone assembly according to claim 2 wherein said transducer is placed in said lid.

4. A mobile phone assembly according to claim 2 wherein said transducer is placed in said housing.

5. A mobile phone assembly according to claim 1 comprising a member that has a sliding connection with said housing, said member comprising at least part of said duct.

6. A mobile phone assembly according to claim 1 including a telescopic arrangement that comprises at least part of said duct.

7. A mobile phone assembly according to claim 6 wherein said telescopic arrangement comprises concentric tubes at least one of which can be parked inside said housing.

8. A mobile phone assembly according to claim 1 wherein said duct is provided by at least one tube.

9. A mobile phone assembly according to claim 1 including a hands-free kit; said kit comprising said transducer, said duct, and a microphone.

10. A mobile phone assembly according to claim 1 including a hands-free kit; said kit comprising said duct, a microphone, and electrical wiring terminating in an electrical connector.

11. A mobile phone assembly according to any preceding claim wherein said duct is several centimeters long.

12. A hands-free kit for a mobile phone comprising:
an electrical cable terminating in a connector,
a microphone for delivering speech signals to said connector via said cable.
an ear-piece for transmitting sound in a first direction,
a transducer for converting electrical signals received from said connector into speech sound; and
a dielectric member having an acoustic duct that extends in a longitudinal direction that is normal to said first direction, said acoustic duct guiding sound generated by said transducer into said ear-piece.

13. A hands-free kit according to claim 12 wherein said duct is between two and twenty centimeters long.
